(19) United States
(12) Patent Application Publication
(10) Pub. No.: US 2026/0134666 A1
(43) Pub. Date: May 14, 2026

(54) COMPUTER-IMPLEMENTED METHOD FOR TRAINING A CLASSIFICATION DEVICE

(71) Applicant: Robert Bosch GmbH, Stuttgart (DE)

(72) Inventors: Hongkuan Zhou, Stuttgart (DE); Lavdim Halilaj, Leonberg (DE); Sebastian Monka, Muenchen (DE); Stefan Schmid, Waiblingen (DE)

(21) Appl. No.: 19/384,809

(22) Filed: Nov. 10, 2025

(30) Foreign Application Priority Data
Nov. 13, 2024 (DE) 10 2024 210 908.8

(51) Int. Cl. G06V 10/774; G06V 10/764

(52) U.S. Cl. CPC G06V 10/774; G06V 10/764

(57) ABSTRACT

A computer-implemented method for training a classification device including an embedding part and a classification part. The method includes: providing a training dataset comprising a plurality of training examples, wherein each training example comprises an input signal and a desired classification, generating a knowledge graph containing additional information linked to at least one desired classification, wherein the additional information is represented by a plurality of knowledge graph entities and by a plurality of knowledge graph relationships linking the knowledge graph entities, providing input signal embeddings by embedding the input signals in a latent space, providing knowledge graph embeddings by embedding the knowledge graph in the latent space, and performing a training based on the input signal embeddings and the knowledge graph embeddings according to a training objective function which is composed of a regularization loss function and a cross-entropy loss function.

### CROSS REFERENCE

The present application claims the benefit under 35 U.S.C. § 119 of Germany Patent Application No. DE 10 2024 210 908.8 filed on Nov. 13, 2024, which is expressly incorporated herein by reference in its entirety.

### FIELD

The present invention relates to a computer-implemented method for training a classification device.

### BACKGROUND INFORMATION

Machine learning techniques that involve training using data (sensor data) often suffer from overfitting problems. These problems occur in particular when there are significant differences between the training and target domains, for example when the data distribution in the training domain differs from that in the target domain. This impairs the predictive ability of the classification device.

It is desirable to provide a method for training a classification device that can achieve high prediction accuracy even when the training domain differs from the target domain.

### SUMMARY

According to a first aspect of the present invention, a computer-implemented method is provided for training a classification device. According to an example embodiment of the present invention, the device includes: an embedding part (e.g., an encoder) which is configured to provide input signal embeddings by embedding input signals in a latent space, and a classification part (e.g., a decoder) which is configured to ascertain a classification on the basis of an input signal embedding, and the the method comprises:
providing a training dataset comprising a plurality of training examples, wherein each training example comprises an input signal and a desired classification, and wherein the training dataset contains synthetically generated training examples as visual prior knowledge,
generating a knowledge graph containing additional information as symbolic prior knowledge linked to at least one desired classification, wherein the additional information is represented by a plurality of knowledge graph entities (nodes) and by a plurality of knowledge graph relationships linking the knowledge graph entities,
providing input signal embeddings by embedding the input signals of the training dataset in the latent space,
providing knowledge graph embeddings by embedding the knowledge graph in the latent space,
performing training based on the input signal embeddings and the knowledge graph embeddings according to a training objective function which is composed of the following:
a regularization loss function to align the input signal embeddings with the knowledge graph embeddings in the latent space, and
a cross-entropy loss function to assign the input signals to the corresponding classifications.

The method according to the present invention can model numerous relationships in the latent space that go beyond “similar” or “dissimilar.” By aligning the input signal embeddings with the knowledge graph embeddings, a regularization, e.g., an adjustment, of the latent space can be achieved, by means of which the generalization ability of the classification device can be improved.

The regularization loss function can, for example, be a categorical or a relational loss function. Using a categorical loss function, it can be achieved that an input signal embedding is located within the node distribution of the knowledge graph. Using a relational loss function, it can be achieved that an input signal embedding in the knowledge graph has defined relationships with other node distributions.

Providing input signal embeddings is conventional. An exemplary method for this is disclosed in A. Dosovitskiy et al.: “An Image is Worth 16×16 Words: Transformers for Image Recognition at Scale,” arXiv:2010.11929. Providing knowledge graph embeddings is also conventional. Purely by way of example, reference is made to the methods disclosed in S. Monka et al.: “Learning Visual Models using a Knowledge Graph as a Trainer,” arXiv:2102.08747 or in S. Monka et al.: “Context-driven Visual Object Recognition based on Knowledge Graphs,” arXiv:2210.11233.

Knowledge graphs store information about real entities and their relationships in the form of triples, such as (subject, predicate, object). The semantic and structural information of such triples is preserved even after knowledge graph embedding.

This semantic and structural information can be used in the method according to the present disclosure for regularizing the latent space. For this purpose, the method can further comprise: forming triples of the form

$$< {z}^{I} , {z}_{i}^{r} , {z}_{j}^{o} > ,$$

where z^{l} is an input signal embedding vector,

$${z}_{i}^{r}$$

to a knowledge graph relationship embedding vector and

$${z}_{j}^{o}$$

is a knowledge graph entity embedding vector, wherein the regularization loss function is used to maximize an evaluation function for triples that correspond to a true statement and to minimize an evaluation function for triples that correspond to a false statement. The knowledge graph entity embedding vectors

$${z}_{j}^{o}$$

can be represented (implemented) as Gaussian embeddings. This allows inclusion relationships, such as “is a subclass of,” to be represented precisely.

It can also be provided that a number N_{I}·N_{O}·N_{R} of triples of the form

$$〈 {z}^{I} , {z}_{i}^{r} , {z}_{j}^{o} 〉$$

is formed, wherein N_{I} is the number of training examples, N_{O} is the number of knowledge graph entities, and N_{R} is the number of knowledge graph relationships. This further development allows maximum utilization of the information contained in the training dataset and the knowledge graph, which is advantageous for regularizing the latent space and thus for improving the generalization ability of the classification device.

The classification device can be configured to classify images, such as traffic signs, wherein the training examples are example training images.

The knowledge graph can comprise object categories and object category elements as knowledge graph entities, and relationships between the object categories and the object category elements as knowledge graph relationships. If the images are images of traffic signs, two object categories, for example, can be provided: “traffic sign” and “traffic sign feature.” The “traffic sign” category can comprise a plurality of subcategories, e.g.: “informative,” “prohibited,” “mandatory” and “warning.” “Traffic sign feature” can be “shape,” “border color,” “background color” or “symbol.”

The object category elements can be linked to knowledge graph entities that are higher in the hierarchy through hierarchical relationships. In addition to hierarchical relationships, the knowledge graph can also comprise assignment relationships, e.g., “has shape,” “has symbol,” “has background color,” and “has border color.”

In addition, the knowledge graph can also contain object category elements in order to account for country-specific representations of certain traffic signs, such as the “hazard” traffic sign. In Germany, this has a white background color and a red border color, while in China it has a yellow background color and a black border.

The generalization ability of the classification device can also be specifically influenced by means of the training dataset and the configuration of the knowledge graph. It can be provided that the object category elements comprise: object category elements that correspond to images recorded using a camera, and object category elements that correspond to synthetically generated images which represent the visual prior knowledge.

In a further aspect of the present invention, a method for classifying sensor data is provided. According to an example embodiment of the present invention, the method comprises:
training a classification device according to a method described above,
detecting sensor data,
classifying the detected sensor data using the classification device.

In a further aspect of the present invention, a data processing device is provided which is configured to perform a method described above for training a classification device according to the present invention. Furthermore, a data processing device is provided which is configured to perform a method for classifying sensor data according to the present invention, as described above. This data processing device can, for example, be mounted in a vehicle and configured to classify sensor data from an image sensor mounted on the vehicle, such as sensor data corresponding to images of traffic signs. The data processing device can access a memory in which parameters are stored which have been ascertained as a result of an above-described method for training a classification device.

In a further aspect, a computer program is provided with commands which, when executed by a processor, cause the processor to perform a method of the present invention described above for training a classification device. Furthermore, a computer program is provided with commands which, when executed by a processor, cause the processor to perform a method of the present invention described above for classifying sensor data.

In a further aspect of the present invention, a computer-readable medium is provided which stores commands which, when executed by a processor, cause the processor to perform a method of the present invention described above for training a classification device. Furthermore, a computer-readable medium is provided which stores commands which, when executed by a processor, cause the processor to perform a method of the present invention described above for classifying sensor data.

In a further aspect of the present invention, a control system for controlling an actuator is provided, wherein the control system comprises a classification device trained using a training method of the present invention described above.

The present invention is described below with reference to the figures.

### BRIEF DESCRIPTION OF THE DRAWINGS

FIG. 1 illustrates an exemplary method for training a classification device, according to the present invention.

FIG. 2 is a schematic representation of a knowledge graph, according to an example embodiment of the present invention.

FIG. 3 is a flowchart of a method for training a classification device, according to an example embodiment of the present invention.

FIG. 4 illustrates an exemplary sequence of a classification process, according to an example embodiment of the present invention.

FIG. 5 is a schematic representation of an exemplary vehicle equipped with a classification device trained in accordance with the present invention.

### DETAILED DESCRIPTION OF EXAMPLE EMBODIMENTS

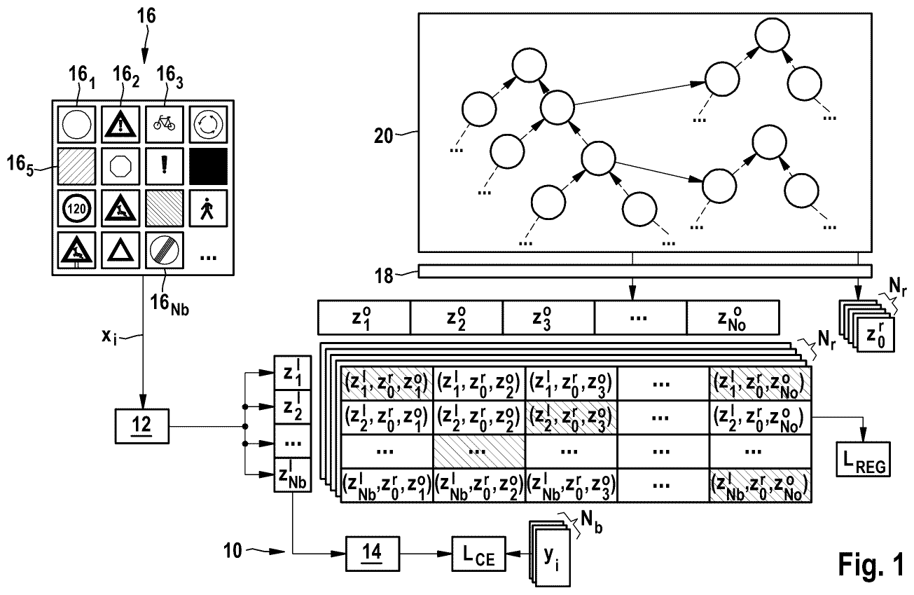

FIG. 1 illustrates the sequence of an exemplary method for training a classification device 10, which device comprises: an embedding part 12 (e.g., an encoder) which is configured to provide input-signal embeddings

$${z}_{i}^{I}$$

by embedding input signals xᵢ in a latent space, and a classification part 14 (e.g., a decoder) which is configured to ascertain classifications yᵢ of the input signals xᵢ on the basis of the input-signal embeddings zᵢ^{l}. One or both of the embedding part 12 and the classification part 14 can comprise or be designed as a relevant neural network. The classification device 10, and thus the embedding part 12 and the classification part 14, can be implemented by hardware, such as a processor and a memory, and by software.

The classification device 10 can be configured to classify images, for example images of traffic signs. The classification device 10 is described below by way of example as such a classification device which is configured to categorize images of traffic signs. However, this is not intended to be limiting, but merely to facilitate the explanation of the principles of the present disclosure.

The starting point of the method is providing a training image dataset 16, which contains a plurality of training images 16₁, . . . , 16_{Nb}, wherein each training image 16₁, . . . , 16_{Nb} comprises an input signal x₁, . . . , x_{Nb} and a desired classification. The training images 16₁, . . . , 16_{Nb} comprise images of real traffic signs (e.g., training images 16₂, 16_{Nb}), i.e., images recorded using a camera, along with synthetic images, such as of shapes (e.g., training image 16₁), symbols (e.g., training image 16₃) or colors (e.g., training image 16₅). The synthetic images can be extracted from images of real traffic signs and modified, for example, rescaled and repositioned. The synthetic images represent visual prior knowledge which is incorporated into the training process.

Furthermore, as shown in FIG. 1, a knowledge graph 20 is provided which contains additional information linked to at least one desired classification. This additional information represents symbolic prior knowledge which is also incorporated into the training process. The visual prior knowledge and the symbolic prior knowledge can also be referred to as multi-modal prior knowledge, which is incorporated into the training process and contributes to improving the generalization ability of the classification device 10.

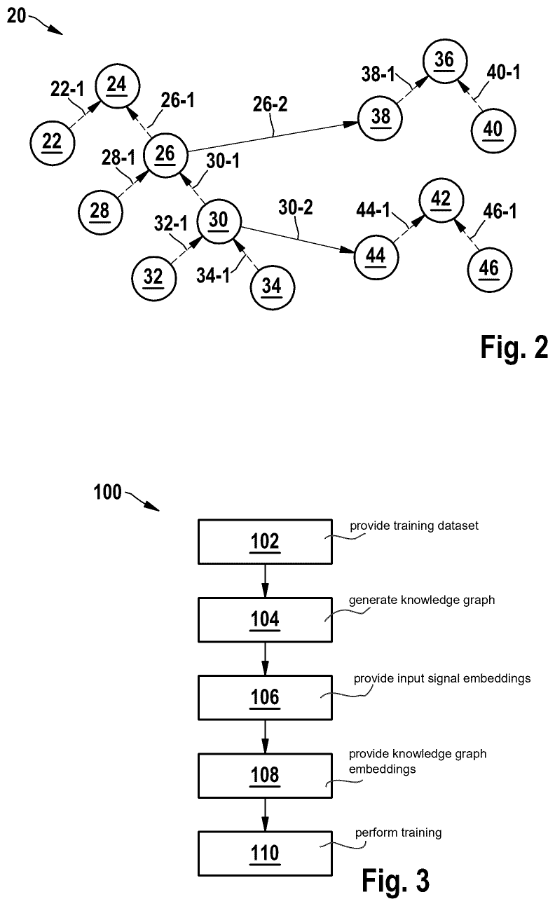

A portion of the knowledge graph 20 is shown enlarged in FIG. 2. As can be seen from FIG. 2, the additional information is represented by a plurality of knowledge graph entities (nodes) 22, 24, 26, 28, 30, 32, 34, 36, 38, 40, 42, 44, 46 and by a plurality of knowledge graph relationships 22-1, 26-1, 26-2, 28-1, 30-1, 30-2, 32-1, 34-1, 38-1, 40-1, 44-1, 46-1 linking the knowledge graph entities 22, 24, 26, 28, 30, 32, 34, 36, 38, 40, 42, 44, 46.

The nodes 22, 24, 26, 28, 30, 32, 34, 36, 38, 40, 42, 44, 46 represent object categories and object category elements. The nodes 22, 24, 26, 28, 30, 32, 34, 36, 38, 40, 42, 44, 46 are arranged hierarchically, wherein the highest hierarchy level is formed by the object categories “traffic sign” 24 and “traffic sign features.” As “traffic sign features,” FIG. 2 includes, by way of example, “traffic sign shapes” 36 and “traffic sign symbols” 42. Other traffic sign features can also be included as object categories in the knowledge graph 20, such as “traffic sign border color” or “traffic sign background color.” Subordinate object category elements follow the highest hierarchy level. In FIG. 2, these are connected to the immediately superordinate node by an assigned dashed arrow.

As object category elements that immediately follow the object category “traffic sign” 24, FIG. 2 shows the object category elements “regulatory sign” 22 and “warning sign” 26. These are connected in an assigned manner to the superordinate node 24 by the dashed arrows 22-1 and 26-1.

In FIG. 2, the “warning sign” node 26 is followed by further subordinate nodes 28 and 30, which are connected in an assigned manner by the dashed arrows 28-1 and 30-1. The nodes 28 and 30 are object category elements (subclasses) of the object category element “warning sign” 26. For example, the node 28 can represent a “traffic jam” traffic sign and node 30 can represent a “hazard” traffic sign. The “hazard” traffic sign 30 can in turn be followed by further subordinate nodes 32 and 34, which take into account different representations of the “hazard” traffic sign in different countries. For example, the node 32 can represent the “hazard” traffic sign in Germany and the node 34 can represent the “hazard” traffic sign in China. The nodes 32 and 34 are connected in an assigned manner to the superordinate node 30 by the arrows 32-1 and 34-1.

In the knowledge graph 20, the object category “traffic sign shapes” 36 is followed by the nodes 38 and 40 as subordinate object category elements, which are connected to the node 36 in an assigned manner by the dashed arrows 38-1 and 40-1. For example, the node 38 can represent the subclass “triangle” as a traffic sign shape. For example, the node 40 can represent the subclass “circle” as a traffic sign shape.

In the knowledge graph 20, the object category “traffic sign symbols” 42 is followed by the nodes 44 and 46 as subordinate object category elements, which nodes are connected to the node 42 in an assigned manner by the dashed arrows 44-1 and 46-1. For example, the node 44 can represent an “exclamation mark” as a traffic sign symbol. The node 46 can, for example, represent an animal symbol, for example in connection with a “wildlife crossing” traffic sign.

In addition to the links between different hierarchy levels, represented by dashed arrows in FIG. 2, the knowledge graph 20 can contain assignment relationships between nodes, which are represented by solid arrows. Assignment relationships can be, for example: “has as shape,” “has as symbol,” “has as border color” or “has as background color.” In FIG. 2, as the assignment relationship, the assignment relationship 26-2 “has as shape” is contained between the nodes 26 and 38, which means that: “warning sign” 26 “has as shape” 26-2 “triangle” 38. As a further assignment relationship, the assignment relationship 30-2 “has as symbol” is contained in FIG. 2 between the nodes 30 and 44. This means that: “hazard” traffic sign 30 “has as symbol” 30-2 “exclamation mark” 44.

The input signals x₁, . . . , x_{Nb} are input into the embedding part 12, which can also be referred to as an image encoder, and embedded in a latent space by means of the embedding part 12. The input signals x₁, . . . , x_{Nb} are in each case transformed into assigned input signal embedding vectors

$${z}_{i}^{I} ∈ {ℝ}^{d} , i = 1 , … , Nb ,$$

where d is the dimension of the latent space. Conventional embedding methods can be used for this purpose, such as the method disclosed in A. Dosovitskiy et al.: “An Image is Worth 16×16 Words: Transformers for Image Recognition at Scale,” arXiv:2010.11929.

The knowledge graph 20 is also embedded in the same latent space as the input signals x₁, . . . , x_{Nb}. The embedding of the knowledge graph 20 can be performed by means of an embedding part 18, which can be configured as a neural network.

Providing knowledge graph embeddings is conventional. Purely by way of example, reference is made to the embedding methods disclosed in S. Monka et al.: “Learning Visual Models using a Knowledge Graph as a Trainer,” arXiv:2102.08747 or in S. Monka et al.: “Context-driven Visual Object Recognition based on Knowledge Graphs,” arXiv:2210.11233.

By embedding the knowledge graph 20, the knowledge graph relationships are transformed into knowledge graph relationship embedding vectors

$${z}_{0}^{r} , … , {z}_{N r}^{r}$$

of the dimension d, and the knowledge graph entities are transformed into knowledge graph entity embedding vectors

$${z}_{1}^{o} , … , {z}_{No}^{o}$$

of the dimension d, where N_{R}=Nr+1 is the number of knowledge graph relationships and No is the number of knowledge graph entities (knowledge graph nodes, nodes).

Since there are a total of No nodes and N_{R}=Nr+1 relationships in the knowledge graph, triples of the form

$$〈 {z}^{I} , {z}_{i}^{r} , {z}_{j}^{o} 〉$$

can be formed for each image embedding vector z^{I}. Such triples contain triples that are explicitly defined in the knowledge graph 20 and triples that are not explicitly defined in the knowledge graph 20. In terms of form, triples that are explicitly defined in the knowledge graph 20 are treated as positive triples, while triples that are not explicitly defined in the knowledge graph 20 are treated as negative triples. Positive triples correspond to true statements, e.g., (stop sign, has as shape, octagon), while negative triples correspond to false statements, e.g., (stop sign, has as shape, triangle). In FIG. 1, the triples with a highlighted background are positive triples and triples with a white background are negative triples.

The triples are provided with the following mask functions:

$${M}_{ij} = \{ \begin{matrix}1 , & if 〈 {e}_{node ( y )} , {r}_{i} , {e}_{j} 〉 ∈ G \\ 1 , & if {r}_{i} = assignment relationship ⋀ j = node ( y ) \\ 0 , & otherwise\end{matrix}$$

G represents the set of triples stored in the knowledge graph 20. eⱼ is a j-th element of the set E of entities of the knowledge graph 20. rᵢ is an i-th relationship of the set R of relationships of the knowledge graph 20. y is the classification of the image in question. node(y) is a function that links the classification of the image to the corresponding node in the knowledge graph 20.

For a specified triple

$$〈 {z}^{I} , {z}_{i}^{r} , {z}_{j}^{o} 〉 ,$$

an evaluation function

$$s ( {z}^{I} , {z}_{i}^{r} , {z}_{j}^{o} )$$

is also defined in such a way that the following relationship applies

$${z}^{I} + {z}_{i}^{r} \approx {z}_{j}^{o} .$$

The image embeddings and the relationship embeddings are represented as vector embeddings. The node embeddings are assumed to be Gaussian embeddings

$${z}_{j}^{o} = ( {μ}_{j} , {\sum }_{j} ) ,$$

where μⱼ denotes the mean and Σⱼ denotes the variance of the corresponding Gaussian distribution.

The evaluation function can thus be defined as follows:

$$s ( {z}^{I} , {z}_{i}^{r} , {z}_{j}^{o} ) = N ( {z}^{I} + {z}_{i}^{r} ; {μ}_{j ,} {\sum }_{j} ) .$$

$$N ( {z}^{I} + {z}_{i}^{r} ; {μ}_{j ,} {\sum }_{j} )$$

denotes the probability density of the vector

$${z}^{I} + {z}_{i}^{r}$$

under the Gaussian distribution with the parameters μⱼ and Σⱼ. During the training phase, two loss functions are minimized: a cross-entropy loss function L_{CE} and a regularization loss function L_{reg}. The cross-entropy loss function L_{CE}(ŷ,y) is used to classify the images into their corresponding classes, where ŷ is the predicted classification and y is the desired classification.

The regularization loss function L_{reg} is used to align the input signal embeddings with the knowledge graph embeddings, as a result of which the latent space is regularized (e.g., adjusted) by means of the prior knowledge incorporated into the knowledge graph 20. The regularization is carried out by optimizing the previously defined evaluation function in such a way that the evaluation function provides a high evaluation for positive triples representing true statements and a low evaluation for negative triples representing false statements.

The regularization loss function L_{reg} is defined as follows:

$${L}_{reg} = \frac{{\sum }_{i , j} {M}_{ij} \cdot {S}_{ij}}{{\sum }_{i , j} {M}_{ij}} + \frac{{\sum }_{i , j} ( 1 - {M}_{ij} ) \cdot max ( 0 , ε - {S}_{ij} )}{{\sum }_{i , j} 1 - {M}_{ij}} .$$

Here, Mᵢⱼ is the previously defined mask,

$${S}_{ij} = - log ( s ( {z}^{I} , {z}_{i}^{r} , {z}_{j}^{o} ) )$$

and ε are a threshold evaluation difference between positive and negative triples.

The entire loss function L can be represented as follows:

$$L = {L}_{CE} + β {L}_{reg} .$$

β is a hyperparameter by means of which a balance is established between the cross-entropy loss term and the regularization loss term.

The following training datasets, for example, can be used as training datasets to perform the method described above:
German Traffic Sign Recognition Benchmark (GTSRB) from Stallkamp, J.; Schlipsing, M.; Salmen, J.; and Igel, C: “The German Traffic Sign Recognition Benchmark: A multiclass classification competition,” The 2011 International Joint Conference on Neural Networks, 1453-1460, 2011,
Chinese Traffic Sign Dataset (CTSD) from Yang, Y.; Luo, H.; Xu, H.; and Wu, F: “Towards real-time traffic sign detection and classification,” IEEE Transactions on Intelligent transportation systems, 17(7), 2015.

FIG. 3 is a flow chart of an exemplary computer-implemented method 100 for training a classification device 10, which device comprises: an embedding part 12 which is configured to provide input signal embeddings by embedding input signals in a latent space, and a classification part 14 which is configured to ascertain a classification on the basis of an input signal embedding, wherein the method comprises:
providing 102 a training dataset comprising a plurality of training examples, wherein each training example comprises an input signal and a desired classification, and wherein the training dataset comprises synthetically generated training examples as visual prior knowledge,
generating 104 a knowledge graph containing additional information as symbolic prior knowledge linked to at least one desired classification, wherein the additional information is represented by a plurality of knowledge graph entities and by a plurality of knowledge graph relationships linking the knowledge graph entities,
providing 106 input signal embeddings by embedding the input signals in a latent space,
providing 108 knowledge graph embeddings by embedding the knowledge graph in the latent space,
performing 110 a training based on the input signal embeddings and the knowledge graph embeddings according to a training objective function L which is composed of the following:
a regularization loss function L_{reg} to align the input signal embeddings with the knowledge graph embeddings in the latent space, and
a cross-entropy loss function L_{CE} to assign the input signals to the corresponding classifications.

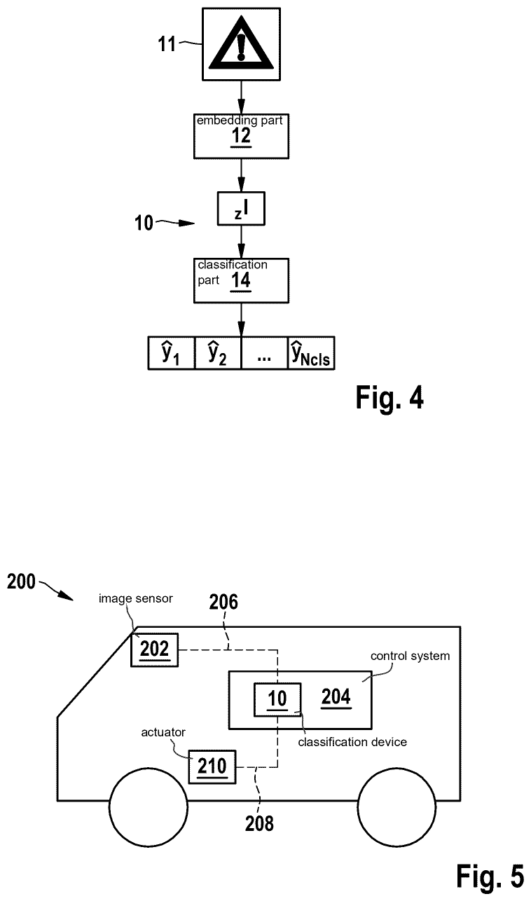

In the use of the classification device 10 trained by means of the method described above, as illustrated in FIG. 4, an image 11, for example recorded by means of an image sensor, is input into the embedding part 12, which provides an image embedding z^{I}, on the basis of which the classification part 14 provides a plurality of classifications ŷ₁, . . . , ŷ_{cls}, from which the classification with the highest probability is selected, as a result of which the classification process is completed.

The preceding method can be performed by one or more computers with one or more data processing units. The term “data processing unit” may be understood as any type of device that allows processing of data or signals. The data or signals can be processed, for example, according to at least one (i.e., one or more than one) specific function which is carried out by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA), or any combination thereof. Any other way of implementing the particular functions described in more detail herein may also be understood as a data processing unit or logic circuit assembly. One or more of the method steps described in detail here can be carried out (e.g., implemented) by a data processing unit by one or more specific functions that are carried out by the data processing unit.

The classification device 10 described by means of the method described above can be used in a control system for controlling an actuator, for example an actuator in a vehicle. The use of the classification device 10 in a vehicle is described below with reference to FIG. 5.

FIG. 5 is a schematic representation of a vehicle 200, which comprises: an image sensor 202 which is configured to record images of a surroundings of the vehicle, a control system 204 comprising the classification device 10, which is configured to receive image signals from the image sensor 202 via a data line 206, and an actuator 210 which is configured to influence a behavior of the vehicle 200. The classification device 10 can classify the received image signals and output a control signal which corresponds to an ascertained classification to the actuator 210 via a data line 208, which causes the actuator 210 to perform an operation according to the ascertained classification.

The actuator 210 can, for example, be part of a braking device of the vehicle 200. The classification device 10 can, for example, be configured to recognize traffic signs and to cause the actuator 210 to perform a braking operation according to the recognized traffic signs, for example when a traffic sign indicating a maximum permissible speed is recognized and it is determined that the current speed of the vehicle 200 is higher than the recognized maximum permissible speed.

What is claimed is:

1. A computer-implemented method for training a classification device, the classification device including: an embedding part which is configured to provide input signal embeddings by embedding input signals in a latent space, and a classification part which is configured to ascertain a classification based on an input signal embedding, the method comprising the following steps:
providing a training dataset including a plurality of training examples, wherein each training example of the training examples includes an input signal and a desired classification, and wherein the training dataset includes synthetically generated training examples as visual prior knowledge;
generating a knowledge graph containing additional information as symbolic prior knowledge linked to at least one desired classification, wherein the additional information is represented by a plurality of knowledge graph entities of the knowledge graph and by a plurality of knowledge graph relationships of the knowledge graph linking the knowledge graph entities;
providing input signal embeddings by embedding the input signals in the latent space;
providing knowledge graph embeddings by embedding the knowledge graph in the latent space; and
performing a training based on the input signal embeddings and the knowledge graph embeddings according to a training objective function which includes the following:
a regularization loss function to align the input signal embeddings with the knowledge graph embeddings in the latent space, and
a cross-entropy loss function to assign the input signals to corresponding classifications.

2. The method according to claim 1, wherein the method further comprises:
forming triples of a form
$$< {z}^{I} , {z}_{i}^{r} , {z}_{j}^{o} > ,$$
where z^{I} is an input signal embedding vector,
$${z}_{i}^{r}$$
is a knowledge graph relationship embedding vector and
$${z}_{j}^{o}$$
is a knowledge graph entity embedding vector, wherein the regularization loss function is used to maximize an evaluation function for those of the triples that correspond to a true statement and to minimize an evaluation function for those of the triples that correspond to a false statement.

3. The method according to claim 2, wherein the knowledge graph entity embedding vectors
$${z}_{j}^{o}$$
are represented as Gaussian embeddings.

4. The method according to claim 2, wherein a number N_{I}·N₀·N_{R} of triples of the form
$$< {z}^{I} , {z}_{i}^{r} , {z}_{j}^{o} >$$
are formed, wherein N_{I} is a number of the training examples, N_{O} is a number of the knowledge graph entities, and N_{R} is a number of the knowledge graph relationships.

5. The method according to claim 1, wherein the classification device is configured to classify images, wherein the training examples are training example images.

6. The method according to claim 1, wherein the knowledge graph includes object categories and object category elements as the knowledge graph entities, and relationships between the object categories and the object category elements as the knowledge graph relationships.

7. The method according to claim 6, wherein visual prior knowledge for the object category elements is provided in a form of synthetically generated images.

8. The method according to claim 7, wherein the object category elements include: object category elements that correspond to images recorded using a camera, and object category elements that correspond to the synthetically generated images.

9. A method for classifying sensor data, the method comprising the following steps:
training a classification device, the classification device including: an embedding part which is configured to provide input signal embeddings by embedding input signals in a latent space, and a classification part which is configured to ascertain a classification based on an input signal embedding, wherein the training includes the following steps:
providing a training dataset including a plurality of training examples, wherein each training example of the training examples includes an input signal and a desired classification, and wherein the training dataset includes synthetically generated training examples as visual prior knowledge;
generating a knowledge graph containing additional information as symbolic prior knowledge linked to at least one desired classification, wherein the additional information is represented by a plurality of knowledge graph entities of the knowledge graph and by a plurality of knowledge graph relationships of the knowledge graph linking the knowledge graph entities;
providing input signal embeddings by embedding the input signals in the latent space;
providing knowledge graph embeddings by embedding the knowledge graph in the latent space; and
performing a training based on the input signal embeddings and the knowledge graph embeddings according to a training objective function which includes the following:
a regularization loss function to align the input signal embeddings with the knowledge graph embeddings in the latent space, and
a cross-entropy loss function to assign the input signals to corresponding classifications;
detecting sensor data; and
classifying the detected sensor data using the classification device.

10. A data processing device configured to perform a method for training a classification device, the classification device including: an embedding part which is configured to provide input signal embeddings by embedding input signals in a latent space, and a classification part which is configured to ascertain a classification based on an input signal embedding, the method comprising the following steps:
providing a training dataset including a plurality of training examples, wherein each training example of the training examples includes an input signal and a desired classification, and wherein the training dataset includes synthetically generated training examples as visual prior knowledge;
generating a knowledge graph containing additional information as symbolic prior knowledge linked to at least one desired classification, wherein the additional information is represented by a plurality of knowledge graph entities of the knowledge graph and by a plurality of knowledge graph relationships of the knowledge graph linking the knowledge graph entities;
providing input signal embeddings by embedding the input signals in the latent space;
providing knowledge graph embeddings by embedding the knowledge graph in the latent space; and
performing a training based on the input signal embeddings and the knowledge graph embeddings according to a training objective function which includes the following:
a regularization loss function to align the input signal embeddings with the knowledge graph embeddings in the latent space, and
a cross-entropy loss function to assign the input signals to corresponding classifications.

11. A non-transitory computer-readable medium on which is stored a commands for training a classification device, the classification device including: an embedding part which is configured to provide input signal embeddings by embedding input signals in a latent space, and a classification part which is configured to ascertain a classification based on an input signal embedding, the commands, when executed by a processor, causing the processor to perform the following steps:
providing a training dataset including a plurality of training examples, wherein each training example of the training examples includes an input signal and a desired classification, and wherein the training dataset includes synthetically generated training examples as visual prior knowledge;
generating a knowledge graph containing additional information as symbolic prior knowledge linked to at least one desired classification, wherein the additional information is represented by a plurality of knowledge graph entities of the knowledge graph and by a plurality of knowledge graph relationships of the knowledge graph linking the knowledge graph entities;
providing input signal embeddings by embedding the input signals in the latent space;
providing knowledge graph embeddings by embedding the knowledge graph in the latent space; and
performing a training based on the input signal embeddings and the knowledge graph embeddings according to a training objective function which includes the following:
a regularization loss function to align the input signal embeddings with the knowledge graph embeddings in the latent space, and
a cross-entropy loss function to assign the input signals to corresponding classifications.

12. A control system for controlling an actuator, comprising:
a classification device, the classification device including: an embedding part which is configured to provide input signal embeddings by embedding input signals in a latent space, and a classification part which is configured to ascertain a classification based on an input signal embedding, the classification device being trained by performing the following steps comprising:
providing a training dataset including a plurality of training examples, wherein each training example of the training examples includes an input signal and a desired classification, and wherein the training dataset includes synthetically generated training examples as visual prior knowledge;
generating a knowledge graph containing additional information as symbolic prior knowledge linked to at least one desired classification, wherein the additional information is represented by a plurality of knowledge graph entities of the knowledge graph and by a plurality of knowledge graph relationships of the knowledge graph linking the knowledge graph entities;
providing input signal embeddings by embedding the input signals in the latent space;
providing knowledge graph embeddings by embedding the knowledge graph in the latent space; and
performing a training based on the input signal embeddings and the knowledge graph embeddings according to a training objective function which includes the following:
a regularization loss function to align the input signal embeddings with the knowledge graph embeddings in the latent space, and
a cross-entropy loss function to assign the input signals to corresponding classifications.
